(19) United States
(12) Patent Application Publication
(10) Pub. No.: US 2025/0129501 A1
(43) Pub. Date: Apr. 24, 2025

(54) COPPER FOIL WITH HIGH ELONGATION RATE AND METHOD OF MANUFACTURING SAME

(71) Applicant: Dong-A University Research Foundation For Industry-Academy Cooperation, Busan (KR)

(72) Inventors: Hyo Jong LEE, Busan (KR); Han Kyun SHIN, Changwon-si (KR); Jung Han KIM, Changwon-si (KR); Hyun PARK, Suwon-si (KR)

(73) Assignee: Dong-A University Research Foundation For Industry-Academy Cooperation, Busan (KR)

(21) Appl. No.: 18/916,293

(22) Filed: Oct. 15, 2024

(30) Foreign Application Priority Data
Oct. 18, 2023 (KR) 10-2023-0139122

(51) Int. Cl. C25D 1/04; C25D 3/38

(52) U.S. Cl. CPC C25D 1/04; C25D 3/38

(57) ABSTRACT

The method of manufacturing a copper foil with a high elongation rate includes: preparing a plating solution by mixing a copper ion, an additive for improving conductivity, a plating inhibitor, and a plating accelerator; and manufacturing the copper foil by immersing a substrate in the plating solution and applying an electric current to the plating solution to electroplate the copper foil on a surface of the substrate.

### CROSS-REFERENCE TO RELATED APPLICATIONS

This application claims the priority benefit under 35 U.S.C. 119(a) of Korean Patent Application No. 10-2023-0139122, filed Oct. 18, 2023 in the Korean Intellectual Property Office, the entire disclosure of which is incorporated herein by reference for all purposes.

### BACKGROUND

### 1. Field

The present disclosure relates to a copper foil with a high elongation rate manufactured by controlling its microstructure and to a method of manufacturing the same.

### 2. Description of the Background

Recently, as the industries related to electronic devices and electric vehicles have grown rapidly, the demand for secondary batteries used in electronic devices and electric vehicles has been rapidly increasing. Accordingly, the demand for a copper foil, which is used as a negative electrode current collector for secondary batteries, has also rapidly increased.

It is generally known that the capacity of a secondary battery can be increased when a copper foil used as an anode current collector of the secondary battery becomes thinner. As a result, the need to increase the capacity of secondary batteries rapidly increases, resulting in a growing demand for copper foil with a thinner thickness.

However, the thinner the copper foil, the weaker the mechanical strength of the copper foil. In particular, a decrease in the elongation rate of copper foil leads to a decrease in toughness, resulting in low reliability of secondary battery products using the copper foil.

Conventionally, in manufacturing a thin copper foil, a recrystallization method including heat treatment is used to improve the mechanical properties by eliminating defects in the copper foil.

However, according to Shin, Han-Kyun, et al. “Multilayer Laminated Copper Electrodeposits and Their Mechanical Properties.” Journal of The Electrochemical Society 169.10 (2022): 102502, when the heat recrystallization method including heat treatment is used, the crystal grains constituting the copper foil grew in the direction of the thickness of the copper foil, thereby a so-called bamboo-like microstructure, which means having one crystal grain along the thickness of the copper foil, is formed, resulting in increasing plastic anisotropy of copper foil.

With the increase in the plastic anisotropy, stress concentration or deformation of the copper foil is observed only in some of the crystal grains constituting the copper foil depending on the deformation direction of the copper foil. Therefore, the mechanical properties such as the elongation rate of copper foil are not effectively increased.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, the method of manufacturing a copper foil with a high elongation rate includes: preparing a plating solution by mixing a copper ion, an additive for improving conductivity, a plating inhibitor, and a plating accelerator; and manufacturing the copper foil by immersing a substrate in the plating solution and applying an electric current to the plating solution to electroplate the copper foil on a surface of the substrate.

The copper foil may include a local grain refinement region when a heat is applied to the copper foil.

The local grain refinement region may be formed by an interaction between the plating inhibitor and the plating accelerator.

Recrystallization of the copper foil may occur in the local grain refinement region.

The copper foil may have an elongation rate per unit thickness of 0.6%/μm or more.

The copper ion may be copper sulfate.

The additive may include: NaCl and sulfuric acid; HCl and sulfuric acid; or NaCl, HCl, and sulfuric acid.

Concentrations of a copper ion, a sulfuric acid, and a chlorine ion in the plating solution may be 0.3 to 1 M, 0.1 to 2 M, and 0.5 to 1 mM, respectively.

The plating inhibitor may be selected from the group consisting of polyethylene glycol, polypropylene glycol, polyethylene imine, gelatin, collagen, and hydroxyethyl cellulose.

The plating inhibitor may be hydroxyethyl cellulose.

A concentration of the hydroxyethyl cellulose may be 50 to 200 ppm.

The plating accelerator may be selected from the group consisting of 3-(Benzothiazolyl-2-thio) propyl sulfonic acid sodium salt, N,N-dimethyl-dithiocarbamic acid-3-(sulfopropyl ester) sodium salt, 3-mercaptopropylsulfonic acid, and bis(sodiumsulfopropyl)disulfide.

The plating accelerator may be bis(sodiumsulfopropyl)disulfide.

A concentration of the plating accelerator may be 0.5 to 1.5 μM.

A molecular weight of the hydroxyethyl cellulose may be 30,000 to 300,000 g/mol.

The manufacturing of the copper foil may include stirring the plating solution at a temperature in a range of 20° C. to 60° C. while applying the electric current to the plating solution.

A current density calculated depending on a reaction area between the plating solution and the substrate may be 100 to 600 mA/cm².

In another general aspect, the copper foil manufactured by the method above is provided.

Other features and aspects will be apparent from the following detailed description and the claims.

### BRIEF DESCRIPTION OF THE DRAWINGS

FIG. 1 is a flowchart for explaining the method of manufacturing the copper foil with a high elongation rate according to an embodiment of the present disclosure.

FIG. 2 is an image showing the results of EBSD analysis of a cross-section of the copper foil manufactured according to Example 1.

FIG. 3 is an image showing the results of EBSD analysis of the cross-section of the copper foil manufactured according to Comparative Example 1.

FIG. 4 is an image showing the results of EBSD analysis of the cross-section of the copper foil manufactured according to Comparative Example 2.

FIG. 5 is an image showing the results of mapping the image obtained through EBSD analysis of the cross-section of the copper foil manufactured according to Example 1 depending on the size of the crystal grains constituting the copper foil.

FIG. 6 is an image showing the results of mapping the image obtained through EBSD analysis of the cross-section of the copper foil manufactured according to Comparative Example 1 depending on the size of the crystal grains constituting the copper foil.

FIG. 7 is an image showing the results of mapping the image obtained through EBSD analysis of the cross-section of the copper foil manufactured according to Comparative Example 2 depending on the size of the crystal grains constituting the copper foil.

FIG. 8 is an image showing the results of EBSD analysis of the cross-section of the copper foil obtained by heat treatment after manufacturing according to Example 1.

FIG. 9 is an image showing the results of EBSD analysis of the cross-section of the copper foil obtained by heat treatment after manufacturing according to Comparative Example 1.

FIG. 10 is an image showing the results of EBSD analysis of the cross-section of the copper foil obtained by heat treatment after manufacturing according to Comparative Example 2.

FIG. 11 is an image showing the results of mapping the image obtained through EBSD analysis of the cross-section of the copper foil obtained by heat treatment after manufacturing according to Comparative Example 1 depending on the size of the crystal grains constituting the copper foil.

FIG. 12 is an image showing the results of mapping the image obtained through EBSD analysis of the cross-section of the copper foil obtained by heat treatment after manufacturing according to Comparative Example 1 depending on the size of the crystal grains constituting the copper foil.

FIG. 13 is an image showing the results of mapping the image obtained through EBSD analysis of the cross-section of the copper foil obtained by heat treatment after manufacturing according to Comparative Example 2 depending on the size of the crystal grains constituting the copper foil.

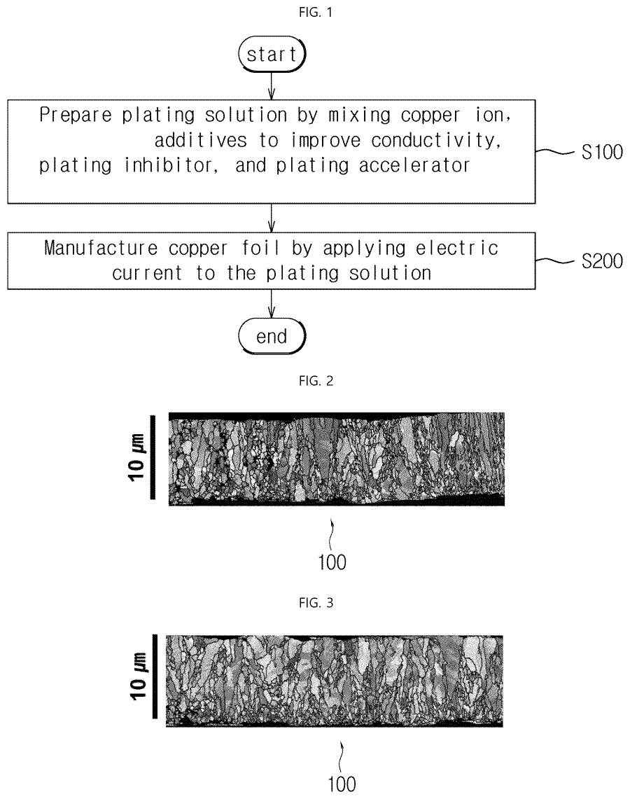

### DETAILED DESCRIPTION

The advantages and features of the present disclosure and methods of achieving them will become clear by referring to the embodiments described in detail below along with the accompanying drawings. However, the present disclosure is not limited to the embodiments disclosed below and will be implemented in various different forms. These embodiments are provided solely to ensure that the disclosure of the present disclosure is complete and to fully inform those skilled in the art of the scope of the present disclosure. Meanwhile, the terms used in this specification are for describing embodiments and are not intended to limit the present disclosure. As used herein, singular forms also include plural forms, unless specifically stated otherwise in the context.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

As used herein, the terms “about,” “substantially,” and the like, are used to mean at or near the numerical value when manufacturing and material tolerances inherent in the meanings stated are presented, and are used to prevent unscrupulous infringers from unfairly exploiting the disclosure in which exact or absolute values are stated to aid understanding of embodiments of the present disclosure.

Herein, the term “combination thereof” included in the expressions in the Markush format refers to a mixture or combination of one or more selected from the group consisting of components described in the expressions in the Markush format, and means including one or more selected from the group consisting of the components.

Herein, the description of “A and/or B” means “A, B, or A and B.”

Herein, terms such as “first” and “second”, or “A” and “B” are used to distinguish the same terms from each other unless otherwise specified.

Herein, the meaning of B being located on A is that B may be located in contact with A or that B may be located on A with another layer interposed therebetween, and is not limited to B being located in contact with the surface of A.

The present disclosure is to provide a copper foil with a high elongation rate by controlling its microstructure to prevent a bamboo-like microstructure increasing plastic anisotropy from being formed, ultimately improving mechanical properties such as elongation rate. In addition, the present disclosure is to provide a method of manufacturing the copper foil. The present disclosure can provide a copper foil with a high elongation rate and a method of manufacturing the same by preventing crystal grains from growing in the thickness direction of the copper foil and a bamboo-like microstructure in the copper foil from being formed during heat treatment.

More specifically, the present disclosure can provide a copper foil by preventing crystal grains from growing in the thickness direction of the copper foil and preventing a bamboo-like microstructure in the copper foil from being formed during heat treatment when the copper foil is manufactured by electroplating. The crystal grain refinement of the copper foil is controlled by adding a plating inhibitor and a plating accelerator into a plating solution during manufacturing.

That is, the present disclosure can provide a copper foil with an improved elongation rate by preventing a bamboo-like microstructure of the copper foil from being formed and then reducing the plastic anisotropy of the copper foil.

The method of manufacturing a copper foil with a high elongation rate is for manufacturing a copper foil with a high elongation rate according to one embodiment of the present disclosure. In describing the copper foil with a high elongation rate and the method according to the embodiments of the present disclosure, for convenience of explanation, substantially the same components are indicated by matching reference numerals, and repeated descriptions are omitted.

Hereinafter, the copper foil with a high elongation rate and the method of manufacturing the same according to embodiments of the present disclosure will be described with reference to the drawings.

The method of manufacturing copper foil with a high elongation rate according to one embodiment of the present disclosure includes preparing a plating solution S100 and plating S200.

First, a plating solution is prepared by mixing a copper ion, an additive for improving conductivity, a plating inhibitor, and a plating accelerator with each other (S100).

Copper sulfate may be used as the copper ion source in the preparation of the plating solution S100, but is not limited thereto. In general, any copper ion capable of being used in the manufacturing of a copper foil by an electroplating method may be used.

In the preparation of the plating solution S100, the plating solution may be prepared by mixing one or more selected from NaCl and HCl as an additive with sulfuric acid to improve conductivity.

In the preparation of the plating solution S100, a plating solution containing copper ions (Cu²⁺), chlorine (Cl⁻) ions, and sulfuric acid may be prepared by mixing copper sulfate, one or more selected from NaCl and HCl, sulfuric acid, and water with each other.

In the preparation of the plating solution S100, the plating solution may be prepared with the copper ions, sulfuric acid, and chlorine ions having concentrations in a range of 0.3 to 1 M, 0.1 to 2 M, and 0.5 to 1 mM, respectively.

In the preparation of the plating solution S100, the copper ions contained in the plating solution are to-be-reduced in the plating S200 so that the copper foil 10 may be manufactured. The copper foil 10 may be manufactured smoothly, when the copper ions contained in the plating solution have a concentration in a range of 0.3 to 1 M.

In the preparation of the plating solution S100, the chlorine ions (Cl⁻) contained in the plating solution may act as an intermediate conductor in the plating process by the reduction reaction of copper ions in the plating S200. When the chlorine ions contained in the plating solution have a concentration in a range of 0.5 to 1 mM, the copper foil 10 may be manufactured smoothly in the plating S200.

In the preparation of the plating solution S100, the plating inhibitor may inhibit plating by reducing the area for the reduction reaction of copper ions when electroplating copper foil on a substrate by applying an electric current to the plating solution in the plating S200.

In the preparation of the plating solution S100, when the plating inhibitor contained in the plating solution has a concentration above a predetermined level, some of the plating inhibitor adsorbed on the substrate surface for the reduction reaction of copper ions may not be desorbed as the copper foil 10 formed thickens during the plating progress in the plating S200, thereby some of the plating inhibitor may be co-deposited onto the copper foil 10, increasing the concentration of impurities in the copper foil 10.

That is, in the preparation of the plating solution S100, when the plating inhibitor is mixed to have a concentration above a predetermined level, the plating inhibitor is co-deposited onto the copper foil 10 as an impurity. Accordingly, even when the copper foil 10 is heat treated, the impurities co-deposited onto the copper foil 10 interfere with the movement of grain boundaries, which may prevent crystal grains from growing in the thickness direction of the copper foil 10.

Thus, in the preparation of the plating solution S100, when the plating inhibitor is mixed to have a concentration above a predetermined level, the plastic anisotropy of the copper foil 10 may decrease after heat treatment of the manufactured copper foil 10. In addition, it is possible to prevent stress from concentrating on some of the crystal grains constituting the copper foil 10 during mechanical deformation of the copper foil 10. As a result, the elongation rate of the copper foil 10 may be improved.

In the preparation of the plating solution S100, when the plating accelerator and plating inhibitor are not mixed together, but only the plating inhibitor is mixed, the plastic anisotropy of the copper foil 10 may decrease after heat treatment of the manufactured copper foil 10. However, as the amount of impurities co-deposited onto the copper foil 10 increases excessively, the brittleness of the copper foil 10 may increase, and the elongation rate of the copper foil may decrease.

In the preparation of the plating solution S100, the plating accelerator mixed may act competitively with the plating inhibitor to refine the crystal grains constituting the copper foil 10.

In the preparation of the plating solution S100, when the prepared plating solution contains a plating accelerator, grain refinement occurs locally due to the competitive action of the plating inhibitor and the plating accelerator, thereby a local grain refinement region, where local recrystallization may occur, is formed on the copper foil 10 according to another embodiment of the present disclosure. During heat treatment of the copper foil 10, recrystallization does not occur throughout the copper foil 10 and may occur only in the aforementioned local grain refinement region. At this point, the local grain refinement region may refer to a region, where crystal grains having a size of several to hundreds of nm are formed.

However, in the preparation of the plating solution S100, when the plating accelerator contained in the plating solution has an excessively high concentration, the local grain refinement region, where recrystallization may occur, is formed throughout the copper foil 10. As a result, during heat treatment of the copper foil 10, recrystallization of the copper foil 10 occurs throughout the copper foil 10, so that the microstructure of the copper foil 10 may be formed into a bamboo-like structure.

More specifically, in the preparation of the plating solution S100, the plating inhibitor may be mixed so that the plating inhibitor has a concentration in a range of 50 to 200 ppm during the preparation of the plating solution. In addition, the plating accelerator may be mixed so that the plating accelerator has a concentration in a range of 0.1 to 10 μM.

In the preparation of the plating solution S100, when the plating inhibitor and plating accelerator are mixed to have a concentration in a range of 50 to 200 ppm and 0.1 to 10 μM, respectively, grain refinement occurs locally due to the interaction between the plating inhibitor and the plating accelerator to form the local grain refinement region. Accordingly, during heat treatment of the copper foil 10 according to a further embodiment of the present disclosure, recrystallization may occur only in the local grain refinement region.

Preferably, in the preparation of the plating solution S100, the plating inhibitor may be mixed so that the plating inhibitor has a concentration in a range of 80 to 120 ppm. In addition, the plating accelerator may be mixed so that the plating accelerator has a concentration in a range of 0.5 to 1.5 μM.

More preferably, in the preparation of the plating solution S100, the plating inhibitor may be mixed so that the plating inhibitor has a concentration of 100 ppm. In addition, the plating accelerator may be mixed so that the plating accelerator has a concentration of 1 μM.

In the preparation of the plating solution S100, when the plating inhibitor mixed has a concentration of less than 50 ppm, the amount of impurities co-deposited onto the copper foil 10 is insufficient. Accordingly, the growth of the copper foil 10 in the thickness direction is not inhibited, so the elongation rate of the copper foil 10 may not be effectively improved.

In the preparation of the plating solution S100, when the plating inhibitor is mixed at a concentration exceeding 200 ppm, the amount of impurities co-deposited onto the copper foil 10 increases, thereby the brittleness of the copper foil 10 increases. Then, the elongation rate of the copper foil 10 may decrease. Additionally, the aforementioned local grain refinement region may not be formed due to the mixing of the plating accelerator.

In the preparation of the plating solution S100, when the plating accelerator has a concentration of less than 0.1 μM, the amount of the plating accelerator is insufficient, so the grain refinement region where recrystallization may occur may not be locally formed in the manufactured copper foil 10. Accordingly, even during heat treatment of the copper foil 10, the mechanical properties of the copper foil 10 may not be effectively improved.

In the preparation of the plating solution S100, when the plating accelerator has a concentration exceeding 10 μM, the local grain refinement region, where recrystallization may occur, may be formed throughout the manufactured copper foil 10. Accordingly, during heat treatment of the copper foil 10, recrystallization occurs throughout the copper foil 10, forming the microstructure of the copper foil 10 into a bamboo-like structure, which may not prevent the plastic anisotropy of the copper foil 10 from increasing.

In the preparation of the plating solution S100, any plating inhibitor commonly used during the electroplating of copper foil may be used as a plating inhibitor. The plating inhibitor may include one or more selected from the group consisting of polyethylene glycol, polypropylene glycol, polyethylene imine, gelatin, collagen, and hydroxyethyl cellulose (HEC), and preferably may include the HEC.

In the preparation of the plating solution S100, the weight average molecular weight of the HEC used as the plating inhibitor is not limited, but may preferably be in a range of 30,000 to 300,000 g/mol.

In the preparation of the plating solution S100, when the HEC used as a plating inhibitor has a molecular weight of more than 300,000 g/mol, the amount of impurities co-deposited into the copper foil 10 is increased, thereby the brittleness of copper foil 10 increases. Then, the elongation rate of the copper foil 10 may rather decrease.

In the preparation of the plating solution S100, any plating accelerator generally used during the electroplating of copper foil may be used as the plating accelerator. The plating accelerator may include one or more selected from the group consisting of 3-(Benzothiazolyl-2-thio) propyl sulfonic acid sodium salt (ZPS), N,N-Dimethyl-dithiocarbamic acid-3-(sulfopropyl ester) sodium salt (DPS), 3-mercaptopropylsulfonic acid (MPSA), and bis (sodiumsulfopropyl)disulfide (SPS), and preferably may include the SPS.

In the preparation of the plating solution S100, copper foil 10 is manufactured by applying an electric current to the prepared plating solution (S200).

In the plating S200, a substrate used may be one, on which copper foil 10 is plated, when an electric current is applied to the plating solution. The substrate may be either a stainless steel (STS) or titanium (Ti) electrode.

In the plating S200, the substrate is immersed in the plating solution prepared in the preparation of the plating solution S100. This may mean manufacturing the copper foil 10 by applying an electric current to the plating solution to electroplate the copper foil on the substrate.

In the plating S200, when immersing the substrate in the plating solution, an anode may be immersed together to apply an electric current to the plating solution. At this point, the anode may be used without limitation as long as the anode is used in the electroplating technology field. The anode may include any one selected from the group consisting of a phosphorus-containing copper electrode, an insoluble iridium oxide (IrO₂) electrode, a platinum oxide (PtO₂) electrode, and a lead (Pb) electrode, and may preferably include the phosphorus-containing copper electrode.

In the plating S200, an electric current may be applied to the plating solution, in which the substrate is immersed, so that the calculable current density may be in a range of 100 to 600 mA/cm² depending on the reaction area between the substrate and the plating solution to manufacture a copper foil 10.

In the plating S200, when the current density calculated depending on the reaction area between the plating solution and the substrate is less than 100 mA/cm², grain growth may occur unevenly during the manufacturing of the copper foil 10.

In the plating S200, when the current density calculated depending on the reaction area between the plating solution and the substrate is more than 600 mA/cm², a side reaction occurs during the manufacturing of the copper foil 10. Thus, the mechanical properties of the copper foil 10 may deteriorate.

In the plating S200, an electric current may be applied to the plating solution while maintaining the temperature of the plating solution at a range of 20° C. to 60° C. and at the same time stirring the plating solution.

In the plating S200, the method of stirring the plating solution is not limited as long as the method does not interfere with the manufacturing of the copper foil 10. The method may include one or more selected from the group consisting of stirring using a magnetic bar, stirring using a paddle, stirring using plating liquid flow and nozzle injection, stirring by the movement of the to-be-plated object itself, and air stirring.

In the case of the copper foil 10 manufactured according to a yet another embodiment of the present disclosure, the formation of the bamboo-like structure of the copper foil is suppressed even after heat treatment, thereby the copper foil may have a high elongation rate per unit thickness. After heat treatment at a temperature in a range of 180° C. to 200° C. for 5 to 15 minutes, the elongation rate per unit thickness of the copper foil 10 may be 0.6%/μm or more. Preferably, after heat treatment at a temperature of 190° C. for 10 minutes, the elongation rate per unit thickness of the copper foil 10 may be 1.4%/μm or more.

When a lithium-ion battery is manufactured by applying copper foil 10 with a low elongation rate, during charging and discharging, lithium ions are precipitated and dissolved in the active layer coated on the copper foil 10, which is accompanied by a change in volume, and the resulting stress on the copper foil 10 may experience problems such as tears or cracks.

The copper foil 10 does not have an upper limit in its elongation rate per unit thickness after heat treatment of the copper foil 10 at a temperature in a range of 180° C. to 200° C. for 5 to 15 minutes, but the upper limit may be 2.0%/μm or less.

### Example 1

A plating solution containing 1 M copper ions, 1 M sulfuric acid, 0.82 mM HCl, 100 ppm HEC, and 1 μM SPS was prepared by mixing copper sulfate, sulfuric acid, HCl, HEC, a plating inhibitor, and SPS, a plating accelerator with each other. HEC with an average molecular weight of 90,000 g/mol was used at this point.

The substrate, anode, and cathode were immersed. Using the anode and cathode, an electric current was applied to the plating solution so that the current density calculated became 500 mA/cm² depending on the reaction area between the plating solution and the substrate. As a result, a copper foil 10 was electroplated on the substrate. At this point, a titanium substrate was used as the substrate, and a phosphorous copper electrode was used as the anode.

During the electric current application, the temperature of the plating solution was maintained at 50° C., and stirring the plating solution was performed using a magnetic bar, thereby a copper foil 10 with a thickness of 10 μm was formed.

### Comparative Example 1

A copper foil 10 was manufactured in the same manner as Example 1 except that the SPS was not mixed during the preparation of the plating solution.

### Comparative Example 2

A copper foil 10 was manufactured in the same manner as Example 1 except that the SPS was mixed to have a concentration of 10 μM instead of 1 μM during the preparation of the plating solution.

### Experimental Example

In the Experimental Example, to confirm the crystal grain structure of the copper foils 10 manufactured according to Example 1 and Comparative Examples 1 to 2, the microstructure of the copper foils 10 was analyzed through electron backscatter diffraction (EBSD) analysis. A mean grain size for copper foils 10 was measured.

More specifically, in the Experimental Example, cross-sectional images of the copper foils 10 were obtained through EBSD analysis. Next, the mean grain size was analyzed by mapping depending on the grain size measured without considering twin boundaries.

To analyze changes in microstructure after heat treatment of the copper foils 10, EBSD analysis was performed on the copper foils 10 manufactured according to Example 1 and Comparative Examples 1 to 2. Next, the copper foils 10 were heat-treated at a temperature of 190° C. for 10 minutes, and then also subjected to EBSD analysis to analyze their microstructure and mean grain size.

In addition, in Experimental Example, to analyze the mechanical properties of the copper foils 10, the tensile strength and elongation rate of the heat-treated copper foils 10 manufactured according to Example 1 and Comparative Examples 1 to 2 were measured using a tensile tester. More specifically, five specimens of the copper foils 10, manufactured according to Example 1 and Comparative Examples 1 to 2 and then heat-treated, were prepared. Then, tensile strength and elongation rate were measured for five specimens.

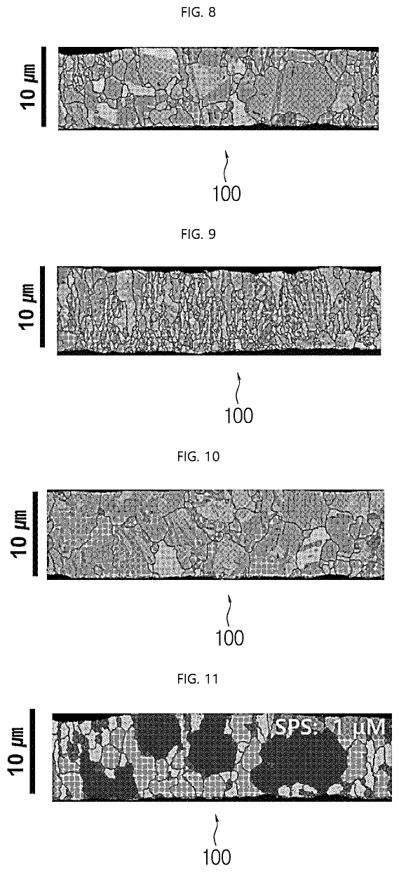

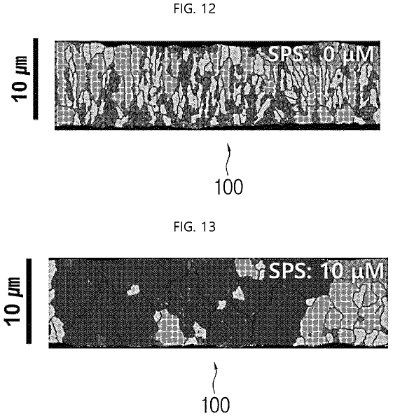

FIGS. 2 to 13 showed images of the copper foils 10 according to EBSD analysis.

More specifically, FIGS. 2 to 4 were images showing the EBSD analysis results of the cross-section of the copper foils 10 manufactured according to Example 1 and Comparative Examples 1 and 2, respectively, before heat treatment. FIGS. 5 to 7 are images showing the mapping results depending on the size of the crystal grains of the copper foils 10, measured without considering the twin boundaries, after EBSD analysis of the cross-section of the copper foils 10 manufactured according to Example 1 and Comparative Examples 1 and 2 before heat treatment.

More specifically, FIGS. 2 to 10 were images showing the EBSD analysis results of the cross-section of the copper foils 10 manufactured according to Example 1 and Comparative Examples 1 and 2, respectively, before heat treatment. FIGS. 11 to 13 are images showing the mapping results depending on the size of the crystal grains of the copper foils 10, measured without considering the twin boundaries, after EBSD analysis of the cross-section of the copper foils 10 manufactured according to Example 1 and Comparative Examples 1 and 2 before heat treatment.

Referring to FIGS. 2, 4, 5, and 7, the copper foil 10 manufactured according to Example 1 had a locally formed grain refinement region during heat treatment, the region being where recrystallization might occur. On the other hand, the copper foil 10 manufactured according to Comparative Example 2 had a grain refinement region formed throughout the copper foil. This means that the grain refinement region was formed throughout the copper foil 10 when the plating accelerator was excessively contained in the plating solution during the manufacturing of the copper foil 10.

In addition, referring to FIGS. 2, 5, 8, and 11, it was confirmed that the copper foil 10 manufactured according to Example 1 had two or more crystal grains in the thickness direction of the copper foil 10 after heat treatment. This means that an excessive amount of a plating inhibitor and a small amount of a plating accelerator contained in the plating solution during the manufacturing of the copper foil 10 might induced grain growth only in the grain refinement region formed locally in the copper foil 10, suppressing the microstructure of the copper foil 10 from being formed into a bamboo-like structure.

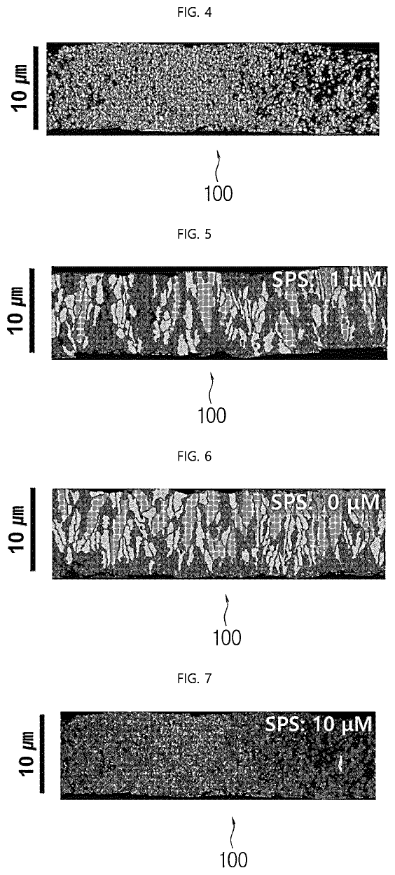

Referring to FIGS. 4, 7, 10, and 13, it was confirmed that the copper foil 10 manufactured according to Comparative Example 2 had a bamboo-like microstructure due to excessive growth of crystal grains in the thickness direction of the copper foil 10 after heat treatment. This means that, when an excessive amount of plating accelerator was contained in the plating solution during the manufacturing of the copper foil 10, resulting in the formation of the grain refinement region throughout the manufactured copper foil 10, grain growth occurred throughout the copper foil 10 during heat treatment, and the microstructure of the copper foil 10 was formed into a bamboo-like structure.

Referring to FIGS. 3, 6, 9, and 12, it was confirmed that crystal grain growth did not occur in the copper foil 10 manufactured according to Comparative Example 1 even after heat treatment. This means that when the plating accelerator was not mixed in the plating solution during the manufacturing of the copper foil 10, grain growth did not occur even after heat treatment of the copper foil 10.

Table 1 shows mean grain size of the copper foil 10 according to Example 1 and Comparative Examples 1 to 2 before and after heat treatment. Table 2 shows tensile strength, elongation rate, and maximum elongation rate of the copper foil 10 after heat treatment.

The “tensile strength” and “average elongation rate” disclosed in Table 2 are obtained by averaging the tensile strength and elongation rate measured for five specimens. “Maximum elongation rate” refers to the highest elongation rate among the five specimens when measuring the elongation rate for each of the five specimens.

In addition, in Table 2, “elongation thickness ratio” refers to the elongation rate per unit thickness of the copper foil 10. “Average elongation thickness ratio” is the ratio of the mean value of the elongation rates measured for 5 specimens to the thickness. “Maximum elongation thickness ratio” is the ratio of the highest elongation rate to thickness among the five specimens.

TABLE 1

| | | Comparative | Comparative |
|---|---|---|---|
| | Example 1 | Example 1 | Example 2 |
| Before heat | 1.24 | 1.57 | 0.35 |
| treatment (μm) | | | |
| After heat treatment | 4.00 | 1.66 | 5.03 |
| (μm) | | | |

TABLE 2

| | | Comparative | Comparative |
|---|---|---|---|
| | Example 1 | Example 1 | Example 2 |
| Tensile strength | 31.94 | 41.32 | 27.74 |
| (kgf/mm²) | | | |
| Average elongation | 14.32 | 5.55 | 4.79 |
| rate (%) | | | |
| Maximum elongation | 17.25 | 8.16 | 5.25 |
| rate (%) | | | |
| Average elongation | 1.432 | 0.555 | 0.479 |
| thickness ratio | | | |
| (%/μm) | | | |
| Maximum elongation | 1.725 | 0.816 | 0.525 |
| thickness ratio | | | |
| (%/μm) | | | |

Referring to Tables 1 and 2, it was confirmed that the elongation rate and maximum elongation rate of the copper foil 10 manufactured according to Example 1 was greater than those of the copper foil 10 manufactured according to Comparative Example 1. It was also confirmed that the mean grain size of the copper foil 10 manufactured according to Example 1 and heat-treated was greater than that of the copper foil 10 manufactured according to Comparative Example 1 and heat-treated. This means that, when the plating accelerator was appropriately mixed with the plating solution during the manufacturing of the copper foil 10, a grain refinement region, where recrystallization might occur, was locally formed in the copper foil 10, thereby recrystallization occurred only in the local grain refinement region during heat treatment of the copper foil 10, improving the elongation rate of the copper foil 10.

In addition, referring to Tables 1 and 2, it was confirmed that the elongation rate and maximum elongation rate of the copper foil 10 manufactured according to Example 1 was greater than those of the copper foil 10 manufactured according to Comparative Example 2. It was also confirmed that the mean grain size of the copper foil 10 manufactured according to Comparative Example 2 and heat-treated was greater than that of the copper foil 10 manufactured according to Example 1 and heat-treated. This means that, when the plating accelerator was excessively mixed in the plating solution during the manufacturing of the copper foil 10, the action of the plating accelerator was excessive during heat treatment of the copper foil 10, thereby the microstructure of copper foil 10 was formed into a bamboo-like structure, causing an inefficient increase in elongation rate.

Those skilled in the art to which the present disclosure pertains will understand that the present disclosure can be implemented in other specific forms without changing its technical idea or essential features. Therefore, the examples described above should be understood in all respects as illustrative and not restrictive. The scope of the present disclosure is indicated by the scope of the claims described below rather than the detailed description above. All changes or modified forms derived from the scope of the patent claims and their equivalent concepts should be construed as being included in the scope of the present disclosure.

What is claimed is:

1. A method of manufacturing a copper foil with a high elongation rate comprising:
preparing a plating solution by mixing a copper ion, an additive for improving conductivity, a plating inhibitor, and a plating accelerator; and
manufacturing the copper foil by immersing a substrate in the plating solution and applying an electric current to the plating solution to electroplate the copper foil on a surface of the substrate.

2. The method of claim 1, wherein the copper foil comprises a local grain refinement region when a heat is applied to the copper foil.

3. The method of claim 2, wherein the local grain refinement region is formed by an interaction between the plating inhibitor and the plating accelerator.

4. The method of claim 2, wherein a recrystallization of the copper foil occurs in the local grain refinement region.

5. The method of claim 1, wherein the copper foil has an elongation rate per unit thickness of 0.6%/μm or more.

6. The method of claim 1, wherein the copper ion is copper sulfate.

7. The method of claim 1, wherein the additive comprises: NaCl and sulfuric acid; HCl and sulfuric acid; or NaCl, HCl, and sulfuric acid.

8. The method of claim 7, wherein concentrations of a copper ion, a sulfuric acid, and a chlorine ion in the plating solution are 0.3 to 1 M, 0.1 to 2 M, and 0.5 to 1 mM, respectively.

9. The method of claim 1, wherein the plating inhibitor is selected from the group consisting of polyethylene glycol, polypropylene glycol, polyethylene imine, gelatin, collagen, and hydroxyethyl cellulose.

10. The method of claim 1, wherein the plating inhibitor is hydroxyethyl cellulose.

11. The method of claim 10, wherein a concentration of the hydroxyethyl cellulose is 50 to 200 ppm.

12. The method of claim 1, wherein the plating accelerator is selected from the group consisting of 3-(Benzothiazolyl-2-thio) propyl sulfonic acid sodium salt, N,N-dimethyl-dithiocarbamic acid-3-(sulfopropyl ester) sodium salt, 3-mercaptopropylsulfonic acid, and bis(sodiumsulfopropyl)disulfide.

13. The method of claim 1, wherein the plating accelerator is bis(sodiumsulfopropyl)disulfide.

14. The method of claim 1, wherein a concentration of the plating accelerator is 0.5 to 1.5 μM.

15. The method of claim 10, wherein a molecular weight of the hydroxyethyl cellulose is 30,000 to 300,000 g/mol.

16. The method of claim 1, wherein the manufacturing of the copper foil comprises stirring the plating solution at a temperature in a range of 20° C. to 60° C. while applying the electric current to the plating solution.

17. The method of claim 1, wherein a current density calculated depending on a reaction area between the plating solution and the substrate is 100 to 600 mA/cm².

18. A copper foil manufactured by the method of claim 1.
